(19) United States
(12) Patent Application Publication
(10) Pub. No.: US 2026/0010858 A1
(43) Pub. Date: Jan. 8, 2026

(54) SYSTEMS AND METHODS TO IDENTIFY AND DISTRIBUTE DIVERSE EVALUATION ASSIGNMENTS

(71) Applicant: NICE LTD., Ra'anana (IL)

(72) Inventors: Rahul VYAS, Jodhpur (IN); LeAnn HOPKINS, Lake Worth, FL (US); Devinder LAMBA, Pune (IN); Abhijit MOKASHI, Pune (IN)

(21) Appl. No.: 18/762,846

(22) Filed: Jul. 3, 2024

(51) Int. Cl. G06Q 10/0639; G06F 40/51

(52) U.S. Cl. CPC G06Q 10/06398; G06F 40/51

(57) ABSTRACT

Interaction distribution systems and methods, and non-transitory computer readable media, include retrieving a diverse evaluation configuration including diverse evaluation configuration rules and diverse interaction category rules; retrieving historical evaluations for each evaluator based on the diverse evaluation configuration rules; retrieving diverse criteria prompt rules; retrieving an interaction transcript associated with each historical evaluation; constructing a large language model (LLM) prompt based on the diverse criteria prompt rules; executing the first LLM prompt on each interaction transcript to return a category of interaction for each interaction transcript; determining evaluation coverage for each returned category of interaction for each evaluator; determining that an evaluator has not evaluated a defined number of interactions for one or more of the diverse interaction category rules; and distributing one or more interactions that match the one or more diverse interaction category rules to the evaluator for evaluation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for distributing diverse interactions for evaluation in contact centers, and more particularly to methods and systems that analyze interaction transcripts using large language models to categorize interactions to ensure that evaluators are evaluating different types of interactions.

### BACKGROUND

In contact centers today, the quality assurance evaluator evaluates customer interactions to ensure that agents are performing according to company standards. To determine an agent's strengths, weaknesses, and coaching opportunities, evaluation is a crucial function, and it requires the services of a qualified evaluator. In some cases, the evaluators manually select random interactions for evaluation. In other cases, a quality management (QM) manager assigns interactions to individual evaluators for evaluation. The QM manager typically is allowed to define very basic and few predefined filters for interaction.

Often, the interactions evaluated are those with high sampling and are filtered using very few common filters, such as channel type, duration of call, or skill of the call agent. Other categories of interactions that are not highly sampled are therefore ignored. This reduces the evaluator's knowledge of these types of interactions that an agent may handle. When evaluators are not evaluating interactions that have a lower sampling, they tend to lose their knowledge of this interaction type, which impacts how accurate they score and how effective their coaching comments are. Inaccuracies in scoring and ineffective coaching comments impact how well an agent is coached and his or her opportunity for improvement.

Even if such an interaction comes up for evaluation, the evaluator's knowledge of how the agent should have handled the interaction is drastically reduced because the evaluator was not challenged to evaluate this type of interaction. This creates a risk of the evaluator not answering the evaluation correctly, or if the evaluator answers the evaluation correctly, the coaching comments in the evaluation may not help the agent handle these interactions. This not only results in the agent not getting fair treatment, but also impacts compliance verification that the evaluator should have done during the evaluation process. Therefore, it is important for the QM manager to give evaluators a diversity of interactions to extend their perspective and improve their ability to effectively evaluate interactions in the long term.

There are few solutions that automate the selection of interactions and send the interaction to an evaluator for evaluation. Moreover, most solutions focus on automating the interaction selection and distribution process, but do not solve the problem of making sure that the evaluators are evaluating all the various appliable categories of interaction.

Accordingly, there is a need for systems and methods that assist managers in identifying repetitive evaluation assignments and distributing diverse evaluations to evaluators. This ensures that evaluators have knowledge of all the possible interactions the agents are handling.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a diverse evaluation system according to embodiments of the present disclosure.

FIG. 2 is an exemplary user interface for configuration of diverse criteria prompt rules according to embodiments of the present disclosure.

FIG. 3 is an exemplary user interface for configuration of diverse evaluation configuration rules according to embodiments of the present disclosure.

FIG. 4 is an exemplary evaluation coverage report according to embodiments of the present disclosure.

FIG. 5 illustrates the data preprocessing stage according to embodiments of the present disclosure.

FIG. 6 illustrates a first part of the data collection stage according to embodiments of the present disclosure.

FIG. 7 illustrates a second part of the data collection stage according to embodiments of the present disclosure.

FIG. 8 illustrates the data utilization stage performed by interaction sampler service according to embodiments of the present disclosure.

FIG. 9 illustrates the data utilization stage performed by diverse prompt rule evaluator service according to embodiments of the present disclosure.

FIG. 10 illustrates the data utilization stage performed by evaluation assignor service according to embodiments of the present disclosure.

FIG. 11 is a flowchart of a method according to embodiments of the present disclosure.

FIG. 12A-12C illustrate the call transcript, prompt rules, and execution of the prompt rules for simulation 1.

FIG. 13A-13C illustrate the call transcript, prompt rules, and execution of the prompt rules for simulation 2.

FIG. 14A-14C illustrate the call transcript, prompt rules, and execution of the prompt rules for simulation 3.

FIG. 15A-15C illustrate the call transcript, prompt rules, and execution of the prompt rules for simulation 4.

FIG. 16A-16C illustrate the call transcript, prompt rules, and execution of the prompt rules for simulation 5.

FIG. 17 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present disclosure analyzes and categorizes previously evaluated interactions by individual evaluators and creates a coverage report (also referred to herein as an “evaluation coverage report”) that details the categories that were previously evaluated. When it is determined that an evaluator has not evaluated a certain number of interactions for a category, the present systems and methods distribute one or more interactions for the under evaluated category to the evaluator. Advantageously, the present disclosure allows the QM manager to define the types of interactions that evaluators must evaluate to keep their knowledge up to date.

In various embodiments, the QM manager defines diverse evaluation configuration rules, which define the categories of interactions that evaluators need to be reviewing, but are not. The diverse evaluation configuration rules identify the blind spots that evaluators are missing.

In one or more embodiments, the diverse evaluation configuration rules define one or more interaction selection rules, names of evaluators, an evaluation assignment schedule, or diverse interaction category rules. In other words, the diverse evaluation configuration rules define the various interaction categories that certain evaluators must evaluate, how many interactions certain evaluators must evaluate, and how often the interactions need to be evaluated.

In some embodiments, the QM manager defines the diverse criteria prompt rules. The diverse criteria prompt rules are rules that categorize interactions.

Application of the diverse evaluation configuration rules and the diverse criteria prompt rules ensures that an interaction transcript is analyzed using large language models (LLM) to categorize the interaction and that evaluators are evaluating all different types of interactions. The power of LLM is used to categorize an interaction into a vast set of categories.

In one embodiment, the present methods include retrieving a diverse evaluation configuration. The diverse evaluation configuration includes the diverse evaluation configuration rules for a plurality of evaluators and the diverse evaluation configuration rules include diverse interaction category rules. Diverse interaction category rules define the categories of interactions that the QM manager wants an evaluator to evaluate. For example, an interaction category rule may be whether a customer mentioned competitors, or a customer requested discounts.

In certain embodiments, the present methods subsequently retrieve historical evaluations for each evaluator mentioned in the diverse evaluation configuration rules by the QM manager. In various embodiments, the interaction transcript associated with each historical evaluation is retrieved for categorization.

In several embodiments, the diverse criteria prompt rules are retrieved and a LLM prompt is constructed based on the diverse criteria prompt rules. For example, if the prompt rule is the agent went speechless, the LLM prompt may be to analyze the interaction transcript and identify if the agent went speechless during the customer query or response.

In some embodiments, the LLM prompt is executed on each interaction transcript to return a category for each interaction transcript associated with each historical evaluation. Once the category is determined for each interaction transcript, evaluation coverage for each returned category of interaction is determined. If it is determined that an evaluator has not evaluated a defined number of interactions for a certain category of interaction, the present systems and methods distribute one or more interactions to that evaluator for that certain category of interaction.

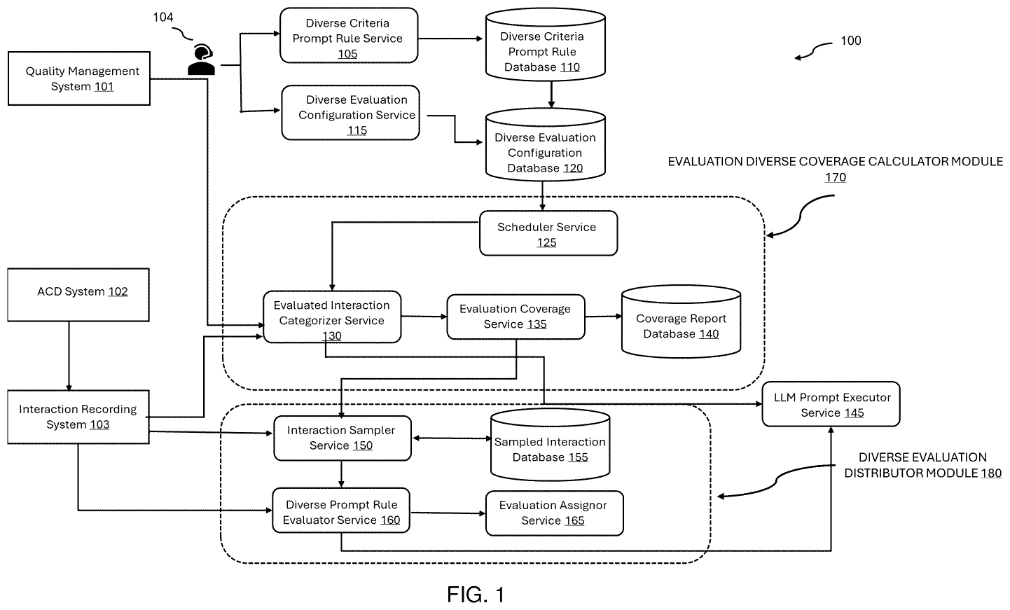

Referring now to FIG. 1, shown is a quality management system 101, an ACD system 102, an interaction recording system 103, and a diverse evaluation system 100 according to embodiments of the present disclosure.

Quality management system 101 generally includes an evaluation service and an evaluation database. The evaluation service is responsible for providing the ability to an evaluator to evaluate interactions. This service stores and manages evaluations in the contact center. In particular, the evaluation service provides the application programing interface (API) to create, assign, submit, and delete evaluations. The evaluation service also provides the API to retrieve the historical evaluations completed by individual evaluators, and is used by evaluated interaction categorizer service 130 to retrieve these historical evaluations. In some embodiments, the evaluation service is used by the evaluation assignor service 165 to create and assign diverse evaluations to an identified evaluator. The evaluation database is the database of the contact center quality management system 101 where all the data of the evaluations are stored. Other data such as agents, teams, tenants, and skills of the agent are also stored in evaluation database.

Automatic communication distributor (ACD) system 102 is the application system that accepts incoming calls or digital interactions and routes them to agents. ACD system 102 also facilitates outbound calls from the agent to the customers. ACD system 102 further allows the contact center to manage its communication routing configuration, which determines which communication should be routed to which agent. Therefore, when an interaction comes, ACD system 102 routes the interaction to an agent.

In various embodiments, ACD system 102 sends the interaction media to the interaction transcription service of the interaction recording system 103. The media can be audio in case of voice interactions or text messages in case of digital interactions. ACD system 102 also sends the interaction metadata to the interaction search service of the interaction recording system 103.

In some embodiments, ACD system 102 connects the agent with the highest proficiency for a given skill or set of skills to a customer. These are typically skills expected to be required in the customer interaction, but alternatively may be overall skills of the agent. Typically, ACD system 102 routes telephone calls, but any type of work item or communication can be given a digital signature and routed via ACD system 102. ACD system 102 is a specialized system that is configured to match a work item to an available agent. ACD systems 102 generally receive incoming work items, determine where to route a particular work item, and connect the work item to an available employee. For the purposes of the present disclosure, “ACD system” refers to any combination of hardware, software and/or embedded logic that is operable to automatically distribute incoming work items, including requests for service transmitted using any audio and/or video means, including signals, data or messages transmitted through voice devices, text chat, web sessions, facsimile, instant messaging and e-mail.

According to one or more embodiments, ACD system 102 includes a processor, a network interface, and a memory module or database. The network interface joins ACD system 102 with a local area network. Once ACD system 102 receives a work item, the processor determines which of a plurality of agents should receive the work item. For example, the processor may access the memory module, which stores code executed by the processor to perform various tasks.

In various embodiments, the processor includes a plurality of engines or modules. Examples of suitable engines include a distributor engine, a queue engine, and a monitor engine. The distributor engine distributes incoming work items to available agents, the queue engine monitors and maintains work items that are waiting to be connected to agents, and the monitor engine checks the status and skills of agents and stores appropriate information in the memory module.

Interaction recording system 103 includes a file storage service, an interaction transcription service, an interaction search service, and an interaction database. Interaction transcription service is responsible for transcribing the audio to text using speech to text services. Interaction transcription service is also responsible for making available transcripts for audio/digital interactions over an API on demand. Interaction transcription service monitors the file storage service for new audio or digital files getting added. For audio files, interaction transcription service runs a speech to text conversion and create a transcript. For digital files, interaction transcription service processes the raw messages into a well formatted transcript. As part of the formatting, interaction transcription service identifies the actors (agent/customer) and the start timestamp of each line in the transcript. Both phone and digital transcripts are stored using the file storage service, and the transcripts are made available over an API by their associated interaction ID.

Interaction search service is responsible for storing the interaction metadata in the interaction database. Interaction search service also provides the ability to search for an interaction from the interaction database using different criteria like users, teams, skills, date range, channel, duration, and other parameters. Accordingly, consumers can better find the right interactions that match their needs or that fill a specified use case.

The diverse evaluation system 100 includes diverse criteria prompt rule service 105, diverse criteria prompt rule database 110, diverse evaluation configuration service 115, diverse evaluation configuration database 120, evaluation diverse coverage calculator module 170 (scheduler service 125, evaluated interaction categorizer service 130, evaluation coverage service 135, and coverage report database 140), LLM prompt executor service 145, and diverse evaluation distributor module 180 (diverse interaction sampler service 150, sampled interaction database 155, diverse prompt rule evaluator service 160, and evaluation assignor service 165). The databases can be any available database technology such as relational databases (e.g., MySQL, PostgreSQL, or Oracle), document databases (e.g., Elasticsearch), or a file system database (e.g., S3). In an exemplary embodiment, each database in the diverse evaluation system 100 includes a MySQL relational database. In some embodiments, each service runs as a microservice inside a docker on the Amazon Web Service Elastic Compute Cloud (AWS EC2) file system and is managed using the AWS Elastic Container Service (ECS).

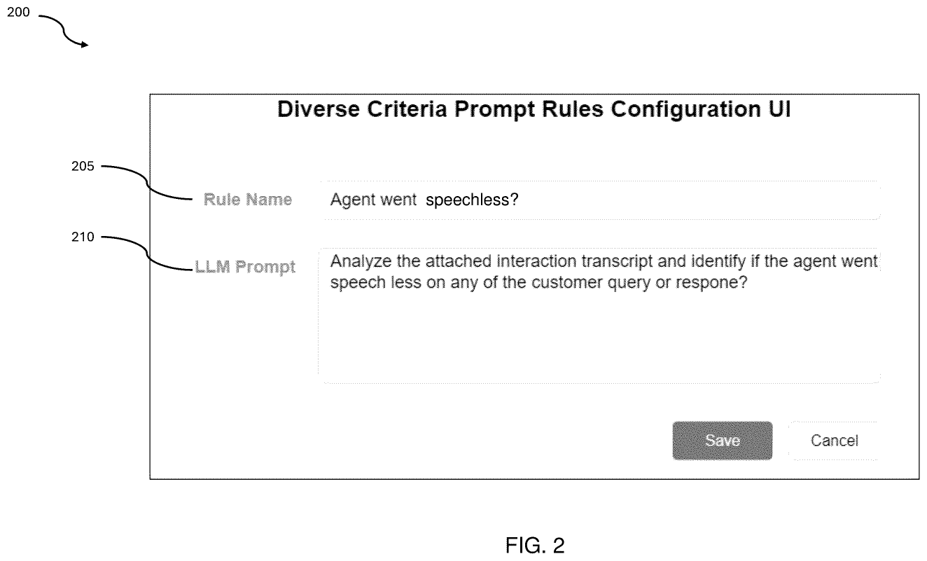

Diverse criteria prompt rule service 105 is responsible for managing diverse criteria prompt rules. In one embodiment, there is a predefined set of rules provided, such as out of the box (OOTB) rules. In other embodiments, QM manager 104 can configure his or her own diverse criteria prompt rule through a user interface 200 shown in FIG. 2 and the rules are then stored in diverse criteria prompt rule database 110. As shown in FIG. 2, configuration of the diverse criteria prompt rules includes providing a rule name 205 and an LLM prompt 210.

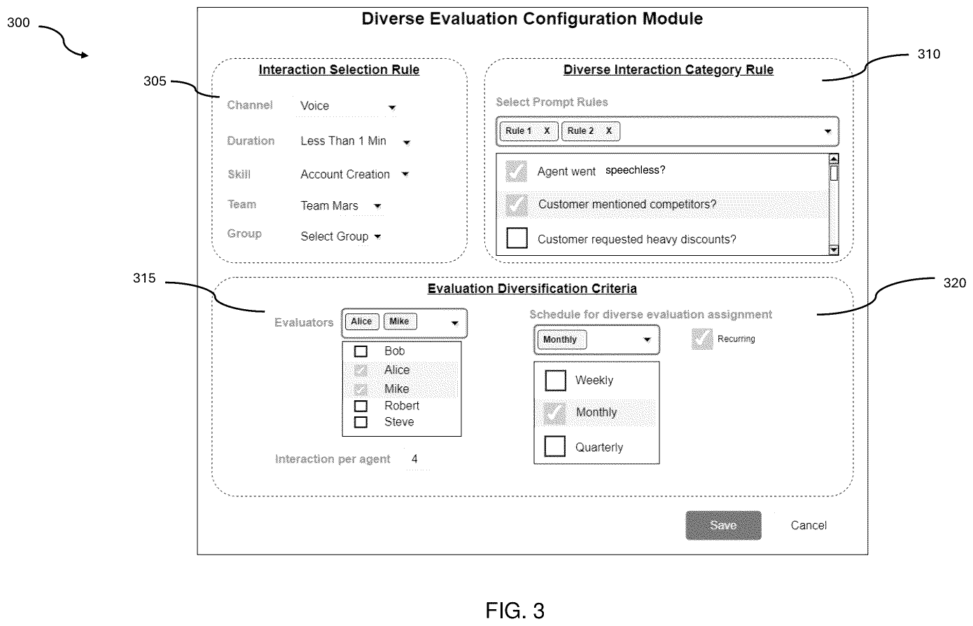

Diverse evaluation configuration service 115 is responsible for managing the diverse evaluation configuration provided by QM manager 104. QM manager 104 can configure the diverse evaluation configuration rules via the user interface 300 shown in FIG. 3. The diverse evaluation configuration rules are stored in diverse evaluation configuration database 120.

As shown in FIG. 3, configuration of the diverse evaluation configuration includes setting up interaction selection rules 305, diverse interaction category rules 310, evaluators 315, and a schedule for diverse evaluation assignment 320. To set up the interaction selection rules, QM manager 104 selects the channel, duration, skill, team, and group of the interaction to be selected. To set up the diverse interaction category rule, QM manager 104 selects the diverse criteria prompt rules he or she wants to use. To set up the evaluators, QM manager 104 selects the evaluators and the interactions to be assigned per agent. Lastly, to set up the schedule for diverse evaluation assignment, QM manager 104 specifies how often diverse interactions should be assigned.

Evaluation diverse coverage calculator module 170 includes scheduler service 125, evaluated interaction categorizer service 130, evaluation coverage service 135, and coverage report database 140. Evaluation diverse coverage calculator module 170 is responsible for scheduling the diverse coverage calculation process at the schedule defined by the diverse evaluation configuration, categorizing an interaction that has been evaluated, storing the categorization, generating an evaluation coverage report for each evaluator, and displaying the evaluation coverage report to QM manager 104. If the coverage is not as expected, evaluation diverse coverage calculator module 170 invokes diverse evaluation distributor module 180.

Scheduler service 125 is responsible for invoking the evaluated interaction categorizer service 130 at the defined schedule in the diverse evaluation configuration rules. Scheduler service 125, at regular intervals, reads the defined diverse evaluation configuration rules using the API of the diverse evaluation configuration service 115. Based on the defined schedule, scheduler service 125 implements a cron scheduler. Once the cron scheduler runs, the scheduler service 125 invokes the evaluated interaction categorizer service 130. As part of the invocation, the entire diverse evaluation configuration entity is passed on to the evaluated interaction categorizer service 130.

Evaluated interaction categorizer service 130 categorizes the interactions that are evaluated by evaluators in a given period. Evaluated interaction categorizer service 130 receives the diverse evaluation configuration that was passed as part of the invocation. The diverse evaluation configuration contains the selected diverse criteria prompt rules. Evaluated interaction categorizer service 130 calls the API provided by diverse evaluation configuration service 115 to fetch the historical evaluations completed by individual evaluators. The evaluation entity has the interaction IDs of the interactions that were evaluated. Evaluated interaction categorizer service 130 then calls the API provided by the interaction search service and file storage service to fetch the interaction metadata and its interaction transcript. Evaluated interaction categorizer service 130 subsequently constructs the LLM prompt that needs to be executed against all the transcripts. The LLM prompt is constructed based on the diverse criteria prompt rules. Later, the generated prompt and each interaction transcript is passed to the LLM prompt executor service 145, which returns the category of each interaction. Finally, the category of each evaluated interaction is passed to evaluation coverage service 135.

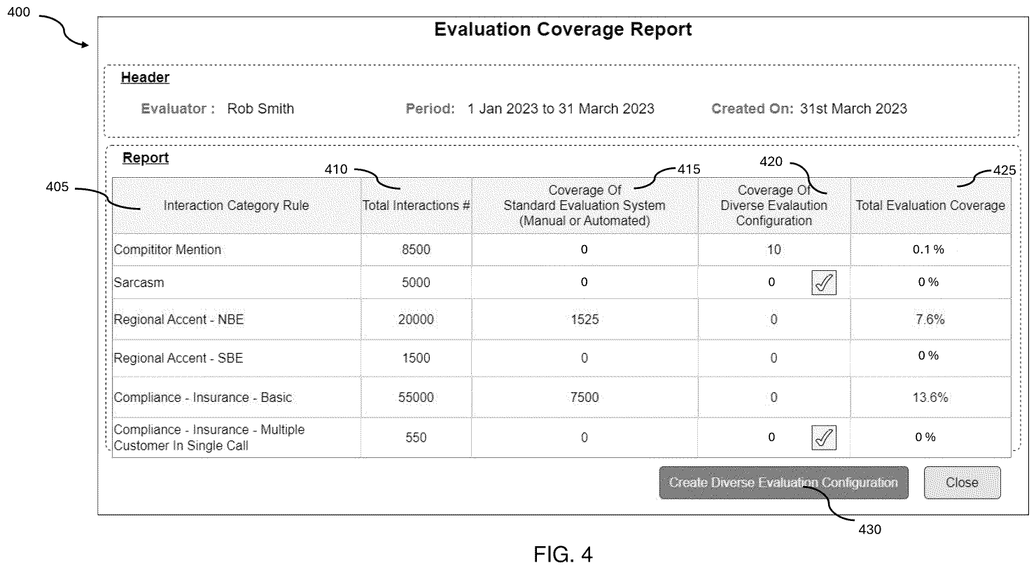

Evaluation coverage service 135 is responsible for preparing the evaluation coverage report of each evaluator, storing the evaluation coverage report, providing APIs to read, update, and delete the evaluation coverage reports, providing a user interface to display the evaluation coverage report, and invoking the diverse evaluation distributor module 180 for each evaluator who has not evaluated the required number of evaluations for any of the selected diverse interaction category rules. For each such evaluator, one or more diverse interactions need to be distributed by the diverse evaluation distribution module 180. In some embodiments, evaluation coverage service 135 presents the evaluation coverage report in the form of a table, as shown in FIG. 4. The evaluation coverage report is saved in coverage report database 140.

Referring to FIG. 4, the evaluation coverage report 400 for an evaluator includes the diverse interaction category rules 405 from the diverse evaluation configuration rules, the total number of interactions in each category 410, the evaluation coverage 415 or the number of interactions in the category evaluated by the evaluator without using the diverse interaction category rules 405 (coverage of standard evaluation system), the diverse plan coverage 420 or the number of interactions evaluated by the evaluator using the diverse interaction category rules 405 (coverage of diverse evaluation configuration) and total evaluation coverage 425. Total evaluation coverage 425 is evaluation coverage 415 divided by the total number of interactions 410. The categories where the total evaluation coverage is 0% are the types of interactions that the evaluator needs to evaluate. In one or more embodiments, the evaluation coverage threshold can be set by the QM manager after the total evaluation coverage calculation is completed from the user interface. The evaluation coverage threshold defines how low the coverage of an interaction category must be to trigger use of a diverse plan.

The evaluation coverage report 400 illustrates that only the category of competitor mention is being evaluated via a diverse plan and that is why the diverse plan coverage 420 is not zero. For the other categories, the diverse plan coverage 420 is zero, which means there is no diverse plan for these categories. For these categories, the QM manager determines if there are enough evaluations done in the evaluation coverage column 415. If the QM manager is satisfied with the number in the evaluation coverage column 415, he or she may decide not to create a diverse plan rule. For example, for the compliance-insurance-basic category, 7500 evaluations were performed, which means an evaluation coverage of 13.6%. In contrast, for the categories of compliance-insurance-multiple customer in single call, sarcasm, and regional accent—SBE, the evaluation coverage is 0% so a QM manager may decide to create diverse plan rules for these categories.

Pushing the “create diverse evaluation configuration” button 430 opens the user interface for the diverse evaluation configuration module seen in FIG. 3. The selected category of “diverse interaction category rule” filter is pre-populated. The QM manager completes the rest of the information and creates the diverse evaluation rule by clicking the “save” button.

LLM prompt executor service 145 is a microservice that exposes representational state transfer (REST) APIs that allow execution of LLM prompts. LLM prompt executor service 145 is built, in one embodiment, using Java Spring Boot technology. LLM prompt executor service 145 is responsible for executing the provided LLM prompt by calling the appropriate APIs of the cloud LLM provider.

Diverse evaluation distributor module 180 is mainly responsible for identifying diverse interactions, and creating and assigning diverse evaluations to evaluators. Diverse evaluation distributor module 180 analyzes the evaluation coverage report and identifies the interaction categories that are not evaluated sufficiently. These are categories of interactions that need to be located and provided to an evaluator. Diverse evaluation distributor module 180 samples the interactions using the defined interaction selection rules. For each sampled interaction, the interaction category is determined by running the diverse criteria prompt rules. If an interaction in the required category is found, an evaluation is created for such interaction and the interaction is assigned to the evaluator who has not evaluated enough interactions in that category.

Diverse evaluation distributor module 180 includes interaction sampler service 150, sampled interaction database 155, diverse prompt rule evaluator service 160, and evaluation assignor service 165. Interaction sampler service 150 is responsible for sampling the interactions per the defined interaction selection rules. Interaction sampler service 150 calls the REST APIs of the interaction search service along with the interaction selection rule that is defined in the diverse evaluation configuration. Once the interaction sampler service 150 gets the matching interaction, it stores it in sampled interaction database 155.

Diverse prompt rule evaluator service 160 is responsible for categorizing the sampled interaction. Diverse prompt rule evaluator service 160 receives the list of sampled interactions as part of the invocation. Diverse prompt rule evaluator service 160 calls the REST API of the file storage service to fetch the transcripts of each sampled interaction. Diverse prompt rule evaluator service 160 then constructs the LLM prompt that needs to be executed against all the transcripts. The LLM prompt is constructed based on the diverse criteria prompt rules. Later, the generated prompt and each interaction transcript is passed to the LLM prompt executor service 145. The LLM prompt executor service 145 returns the category of each interaction. Finally, the category of each sampled interaction is passed to the evaluation assignor service 165.

Evaluation assignor service 165 is responsible for identifying the evaluator and assigning evaluations to the identified evaluator. Evaluation assignor service 165 receives the categories of sampled interactions as part of the invocation. Evaluation assignor service 165 also receives the evaluation coverage report as part of the invocation. Evaluation assignor service 165 then analyzes the evaluation coverage report for each evaluator and identifies the category of interaction that the evaluator has not evaluated. For such categories, evaluation assignor service 165 then checks if the interaction with such category exists in the sampled interactions. If it finds a match, then evaluation assignor service 165 calls the REST API of the evaluation service to create and assign the interaction to the evaluator for evaluation. As part of the API call, the evaluation assignor service 165 passes evaluator and interaction details to the evaluation service. Such process is executed for each evaluator in the evaluation coverage report.

According to one or more embodiments, the present methods can be divided into three stages: (1) the data preprocessing stage, (2) the data collection stage, and (3) the data utilization stage. Each of these stages are described in detail below.

### Data Preprocessing Stage

The main purpose of this stage is to collect diverse evaluation configuration rules that were saved by QM manager 104 in FIG. 3, and to retrieve evaluated interaction transcripts.

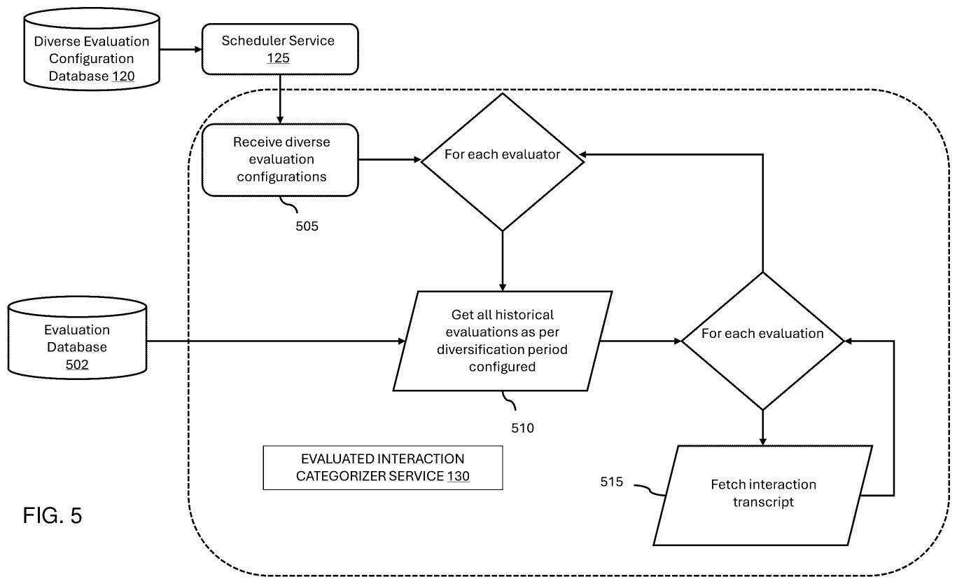

The first step is to collect diverse evaluation configurations per the schedule. Referring now to FIG. 5, scheduler service 125 is invoked in its configured schedule (e.g., weekly, quarterly, or monthly) and retrieves all diverse evaluation configurations stored inside diverse evaluation configuration database 120. Once the configuration data has been collected, it is passed to evaluated interaction categorizer service 130 via REST API.

The next step is to retrieve the evaluated interaction transcripts per evaluator. Once the diverse evaluation configuration is received by the evaluated interaction categorizer service 130 in step 505, it will iterate over all the evaluators and based on the diversification period configured, it will fetch all the historical evaluations completed by the given evaluator from the evaluation database 502 in step 510. Once all evaluation records have been retrieved, the evaluation record is associated with an interaction ID. This is the ID of the interaction evaluated. Evaluated interaction categorizer service 130 retrieves the interaction transcript associated with the given interaction ID in step 515. The interaction can be a voice interaction, an e-mail, an interaction over a digital channel, etc. The interaction transcript associated with the given interaction ID is retrieved from any cloud based managed file storage service such as a simple storage service (S3) bucket.

These steps are performed iteratively and once every evaluated interaction transcript is retrieved, it is shared in the data collection stage.

### Data Collection Stage

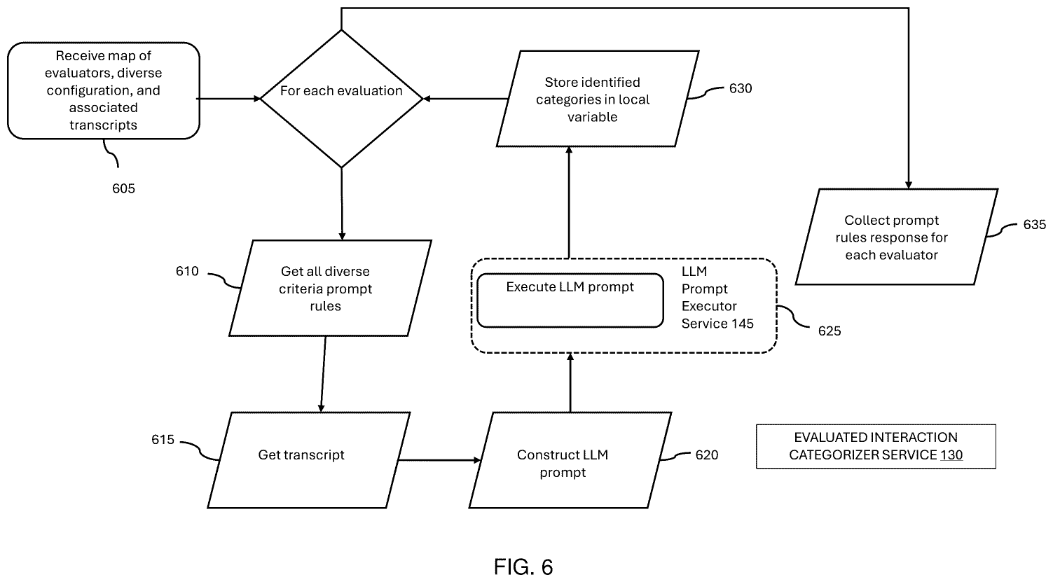

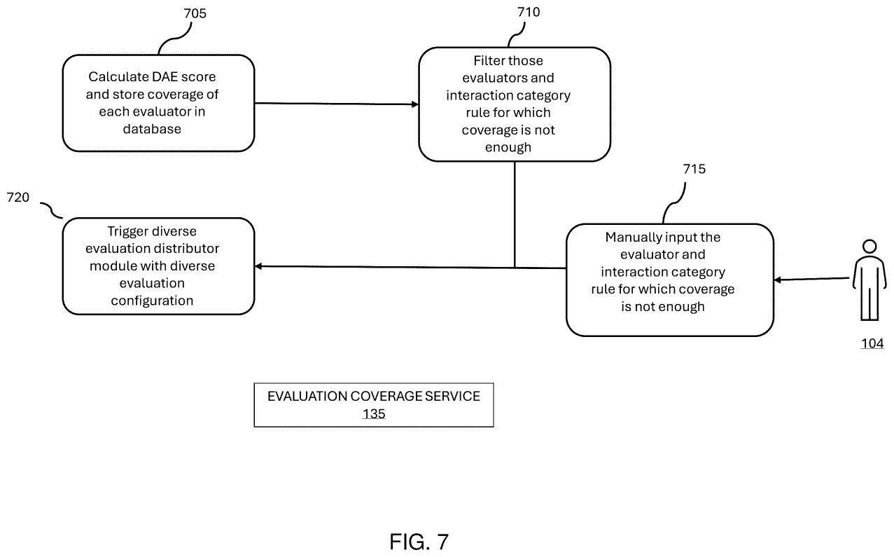

The main purpose of this stage is to categorize each interaction by executing the diverse criteria prompt rules, build an evaluation coverage report, and trigger the diverse evaluation distributor module 180. This entire process is performed by evaluated interaction categorizer service 130 as seen in FIGS. 6 and 7.

The first step is to categorize each interaction by executing the diverse criteria prompt rules. Once evaluated interaction categorizer service 130 receives a map of the evaluators, diversification configuration, and evaluated interaction transcripts in step 605, the LLM prompt is constructed iteratively. To construct the prompt at step 620, the diverse criteria prompt rules are retrieved from the configuration object at step 610 and the associated transcript at step 615. These are embedded in an LLM prompt in a variable. After building the prompt, a REST API call is made to LLM prompt executor service 145 in step 625, which helps in executing the prompt. The prompt execution response contains the category of the interaction, which is stored in a local variable in step 630 for later use. For each evaluation, the evaluated interaction categories for each evaluator are collected at step 635. Once LLM prompts are executed for all the interactions, the response data is embedded inside an evaluation object, and it is passed to the evaluation coverage service 135 for further processing.

The next step is to build the evaluation coverage report and trigger the diverse evaluation distributor module 180. This entire process is performed by evaluation coverage service 135.

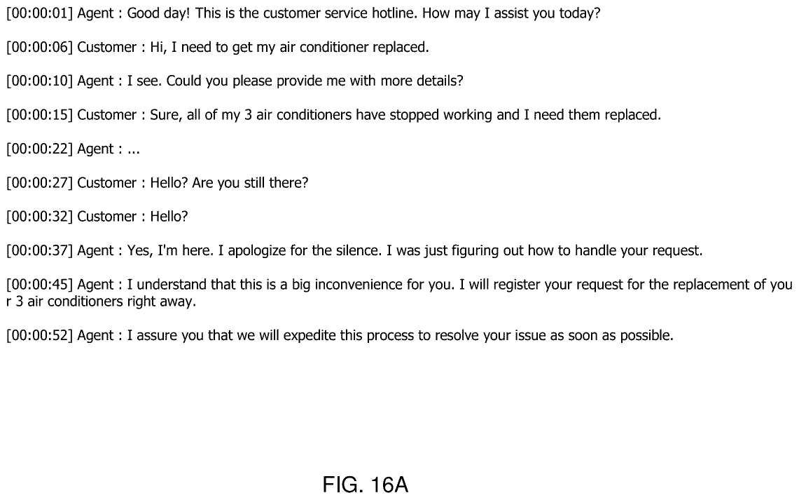

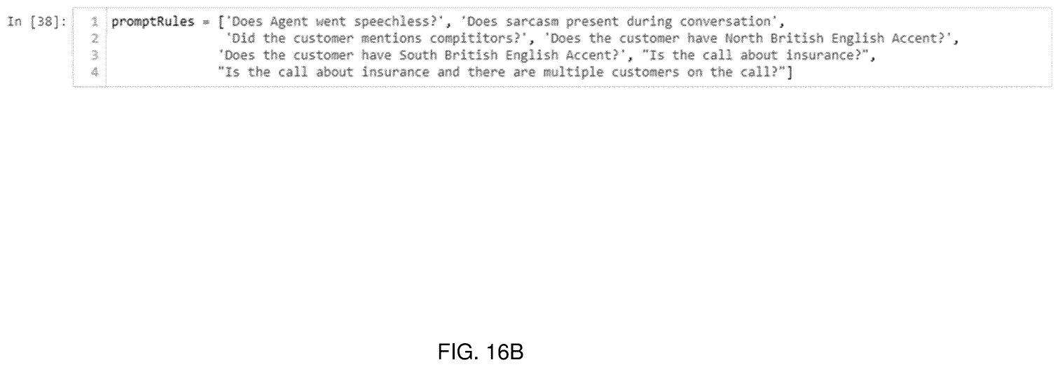

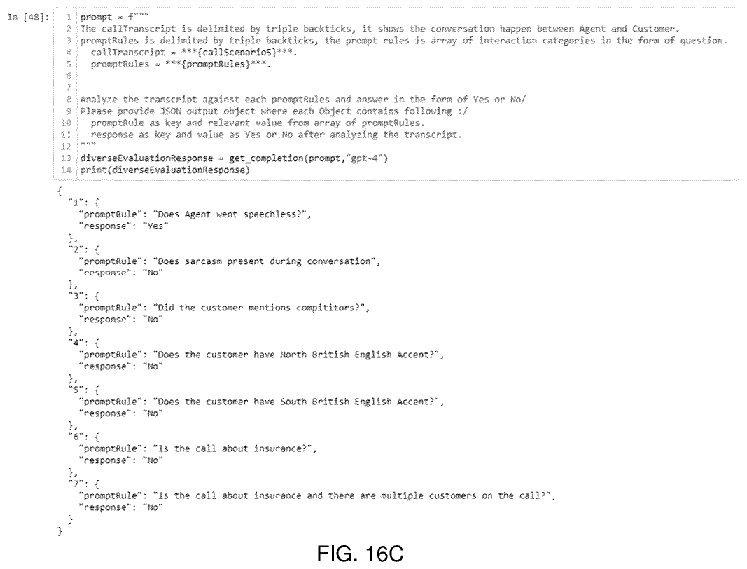

To build the evaluation coverage report, the diverse assignment of evaluation (DAE) score is calculated for each of the evaluators. To calculate the DAE score, evaluation coverage service 135 iteratively retrieves the prompt rule response for each category of the evaluator. The DAE score is the ratio between the total positive response for a given category to the total prompt category rules configured. For example, referring to FIG. 16C, there are a total of 7 prompt category rules, and only one category for which there is a positive response (prompt rule 1). Here, the DAE score would be 1/7. The threshold DAE score for a category to be considered not sufficiently covered can be decided and pre-configured by the organization. The DAE score is the total evaluation coverage percent in evaluation coverage report 400. Once the score is calculated and coverage determined in an evaluation coverage report, it is stored in a database in step 705 in FIG. 7.

There are two ways by which the diverse evaluation distributor module 180 can be triggered by using the evaluation coverage service 135 as shown in FIG. 7. In the manual approach, QM manager 104 reviews the evaluation coverage report in step 710. If he or she finds out the coverage of certain categories is not enough for a certain evaluator in step 710, then he or she can select the certain categories in step 715. The diverse evaluation distributor module 180 will then be triggered along with similar coverage report data.

In the automated approach, evaluation coverage service 135 filters out those evaluators and associated category rules where diverse evaluation coverage is not enough in step 710. Once it has been filtered, then diverse evaluation distributor module 180 is triggered by passing the evaluation coverage report data, which is embedded inside an evaluation object in step 720. The evaluation coverage report data includes a list of evaluators and its prompt category rules for which coverage was not enough.

### Data Utilization Stage

In this stage, desired sampled interactions per evaluator are retrieved, sampled interactions matching required categories are analyzed and selected, and diversified sampled interactions are assigned to evaluators.

An evaluation coverage report for all evaluators is passed to the interaction sampler service 150. The evaluation coverage report includes a list of evaluators and the diverse category rules that need to be evaluated. The interaction sampler service 150 is responsible for fetching the desired sampled interactions. The steps involved with sampling is described below.

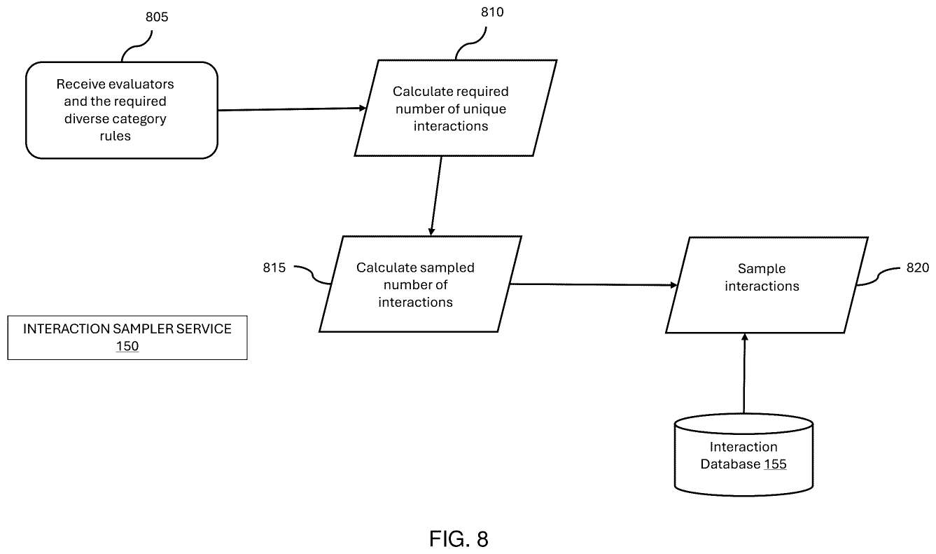

As shown in FIG. 8, interaction sampler service 150 receives the evaluators and the required diverse category rules in step 805. Next, the required number of unique interactions is calculated in step 810. In this step, the overall required number of unique interactions needed is calculated. Suppose there are three (3) evaluators: Jack, Joe, and Adrian, which each need the following interaction categories.

TABLE 1
REQUIRED INTERACTION CATEGORIES
FOR EVALUATORS

| | | Interaction | Total |
|---|---|---|---|
| Evaluators | Channel Type | Categories | Interactions |
| Jack | Voice | Compliance | 5 |
| Joe | Digital channel | Sarcasm | 2 |
| Adrian | Digital channel | Sarcasm | 2 |

Per the table, the total required digital channel interactions related to the sarcasm category is 4, and the total required voice channel interactions related to the compliance category is 5. So a total of 9 unique interactions are needed to be distributed among the evaluators. To obtain the 9 unique interactions, a sampling factor is applied to ensure that a satisfactory number of interactions for the categories are available during the distribution phase.

If the sampling factor is 5, then the total digital channel interactions for the sarcasm category is 5*4=20. The total voice channel interactions related to the compliance category is 5*5=25. Therefore, 25+20=45 interactions need to be sampled from interaction database 155. In step 815, the sampled number of interactions is calculated.

In step 820, the relevant interactions are sampled by querying interaction database 155. For sampling the interactions, the interaction selection rules are used. See FIG. 3. The sampled interactions are then passed to the diverse prompt rule evaluator service 160.

Now that the relevant interactions are sampled, the sampled interactions are analyzed to determine if they match the required categories. Diverse prompt rule evaluator service 160 receives the sampled interactions and the evaluation object containing the diverse criteria prompt rules in step 905. This information is used to identify the interaction category available in the sampled interactions.

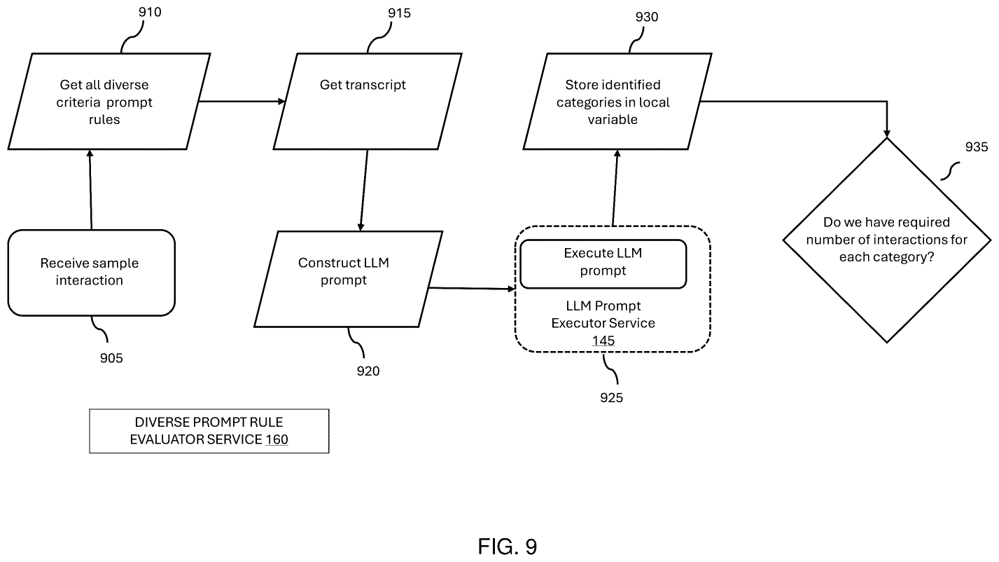

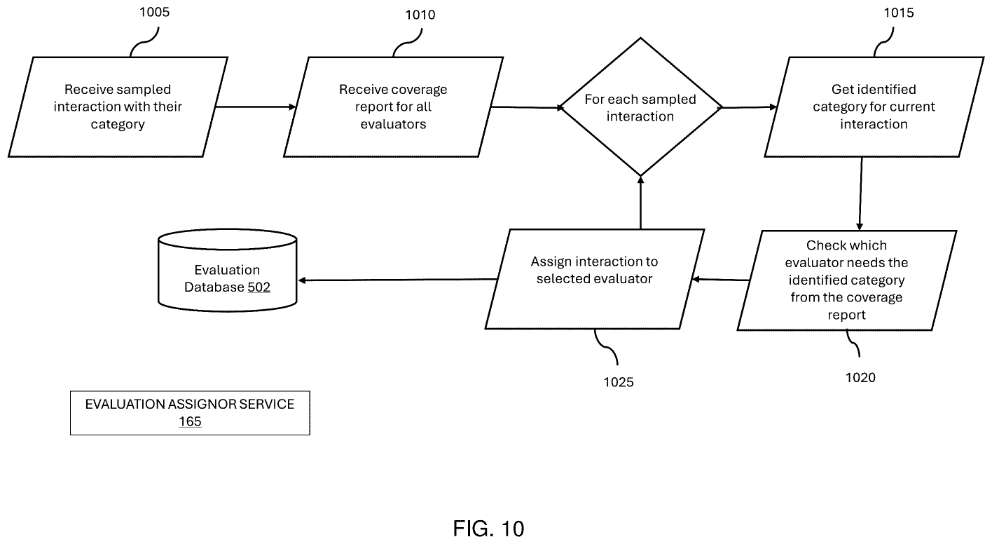

Diverse prompt rule evaluator service 160 constructs the LLM prompt iteratively for all the sampled interactions by fetching the diverse criteria prompt rules at step 910 and obtaining the transcript of the interaction in step 915 in FIG. 9. At step 920, the LLM prompt is constructed. At step 925, the desired prompt is executed by the LLM prompt executor service 145, and the response is collected for each sampled interaction. If the sampled interaction qualifies for any of the diverse criteria prompt rules, then it is filtered out and the relevant interaction categories are stored in the local variable at step 930.

After execution of the LLM prompt for all sampled interactions and applying filtering, the desired number of interactions for each category available to be distributed among the evaluators is calculated in step 935. In the above example, 9 different interactions are needed. If there are enough interactions, then the relevant interaction data is passed to evaluation assignor service 165. If an insufficient number of interactions in the required categories is not available, then a request for more sampled interactions is made by invoking the interaction sampler service 150.

Once the desired number of interactions in the required categories are available, the diversified sampled interactions are assigned to the appropriate evaluators. Evaluation assignor service 165 is responsible for assigning and distributing the sampled interactions.

Evaluation assignor service 165 receives the sampled interactions and their category in step 1005 and receives the evaluation coverage report for all evaluators in step 1010. Evaluation assignor service 1015 obtains the identified category for each interaction in step 1015. The process iterates over each sampled interaction, and from the evaluation coverage report finds the evaluator who needs the category in step 1020. After all the iterations are preformed, the final list of evaluated interactions per evaluator is prepared that can be passed to the evaluation assignor service 165. After all iterations, the required categories of interactions for each evaluator is determined and the interactions are assigned to each evaluator in step 1025.

Evaluation assignor service 165 receives the desired interaction data to be distributed via REST API. It will then create the evaluation tasks for the evaluators in evaluation database 502 using decentralized autonomous organization (DAO) call. In this way, the diversified evaluation tasks are made available to the evaluators.

Below are the relevant data structures.

```
1. Diverse Evaluation Configuration
  {
          ″id″:″873422322-5634-6671-abc2-26jh52jj45″,
          ″tenant_id″:″iuj238h2-kj29-kj23-j23k-iou203iu3222″,
          ″creation_time″:″2020-11-10 12:34:55.668 Z″,
          ″intercation_selection_rule″:{
            ″channel″:″Voice″,
            ″duration″: 356,
            ″skill″:″Account Creation″
          },
          ″diverse_interaction_category_rule″:[
            {
              ″prompt_rule_id″:″873422322-5634-6671-ad24-jh2652jh45″,
              ″prompt_rule_{——}name″:″Agent went speach less?″,
              ″prompt_rule_{——}llm_prompt_text″:″Analyze the attached
  interaction transcript and identify if the agent went speech less on any of the customer
  query or respone?″
            },
            {
              ″prompt_rule_id″:″882489231-8891-2214-25jh-ad2652ef45″,
              ″prompt_rule_{——}name″:″Customer mentioned competitors″,
              ″prompt_rule_{——}llm_prompt_text″:″Analyze the attached
  interaction transcript and identify if the customer mentioned about any competitors of the
  agent's company?″
            }
          ],
          ″evaluation_diversificaiton_criteria″:{
            ″team_id″:″09d58205-9333-4f76-ad8f-2628a6707c0b″,
            ″group_id″:″873422322-8a65-7ac4-ad24-jh2652jh45″,
            ″interaction_per_agent″:4,
            ″diverse_evaluation_assignment_period″:″5 Days″,
            ″diverse_assignment_schedule″:″Monthly″,
            ″is_auto_renew_diversification″:true,
            ″is_stop_other_evaluation″:false
          }
  }
2. Diverse Criteria Prompt Rule
  {
          ″id″:″873422322-5634-6671-ad24-jh2652jh45″,
          ″tenant_id″:″iuj238h2-kj29-kj23-j23k-iou203iu3222″,
          ″rule_name″:″Agent went speach less?″,
          ″rule_llm_prompt_text″:″Analyze the attached interaction transcript and identify
  if the agent went speech less on any of the customer query or respone?″
          ″creation_time″:″2020-11-10 12:34:55.668 Z″,
  }
3. Evaluation Entity
  {
          ″evaluation_id″:″87342472-9832-6522-ad24-jh2652jh45″,
          ″tenant_id″:″iuj238h2-kj29-kj23-j23k-iou203iu3222″,
          ″interaction_id″:″78346387-9838-k3kj-98jj-3489757889″,
          ″agent_user_id″:74891748971,
          ″evaluator_user_id″:312133123123,
          ″creation_time″:″2020-11-10 12:34:55.668 Z″,
  }
4. Interaction Entity
  {
          ″interaction_id″:″78346387-9838-k3kj-98jj-3489757889″,
          ″tenant_id″:″iuj238h2-kj29-kj23-j23k-iou203iu3222″,
          ″start_time″:″2020-11-10 12:34:55.668 Z″,
          ″end_time″:″2020-11-10 12:38:12.345 Z″,
          ″channel″:″PHONE″,//other possible value - EMAIL/CHAT/SMS
          ″direction″:″INCOMING″,//other possible values - outgoing
          ″customer_id″:″12787248974017124″,
          ″ani″:″334 445 9893″,
          ″dnis″:″374 875 9832″,
          ″agent_users″:[
            {
              ″id″:″98398221-2323-edb0-8732-372372871972″,
              ″skill″:″TERM_INSURANCE″.
              “team_id”: “65267126-0923-kj22-2652-983kjnbv38382”
            },
            {
              ″id″:″11e70afb-172e-edb0-b9f3-0242ac110002″,
              ″skill″:″ACCOUNTING”,
              “team_id”: “65267126-0923-kj22-2652-983kjnbv38382”
            }
          ],
          ″recordings″:[
            {
              ″id″:″09d58205-9333-4f76-ad8f-2628a6707c0a″,
              ″type″:″audio″,
              ″start_time″:″2020-11-10 12:34:55.668 Z″,
              ″end_time″:″2020-11-10 12:35:52.268 Z″,
              ″media_location″ :
  ″ftp://recorded_media_files/2394823098423/part1.mp4″
            }
          ]
  }
5. Interaction Transcript
  {
    ″id″: 124553,
    ″interactionId″: ″ad86d017-19a7-405f-be50-90de2035213d″,
    ″tenantId″: ″11ed1163-441d-0360-ac0b-0242ac110005″,
    ″utterences″: [
      {
        ″id″: 1,
        ″speakerType″: ″customer″,
        ″speakerId″: ″customer@socialmedia.com″,
        ″utterenceText″: ″I need help with password″,
        ″timestamp″: ″2022-09-17 19:08:16.259″
      },
      {
        ″id″: 2,
        ″speakerType″: ″Agent″,
        ″speakerId″: ″Bob″,
        ″utterenceText″: ″Sure, how can I help you?″,
        ″timestamp″: ″2022-09-17 19:08:16.712″
      },
      {
        ″id″: 3,
        ″speakerType″: ″customer″,
        ″speakerId″: ″customer@socialmedia.com″,
        ″utterenceText″: ″I forgot my password″,
        ″timestamp″: ″2022-09-17 19:08:21.349″
      },
      {
        ″id″: 4,
        ″speakerType″: ″Supervisor″,
        ″speakerId″: ″Alice″,
        ″utterenceText″: ″Show empathy and suggest using self-service portal
  https://nice.com″,
        ″timestamp″: ″2022-09-17 19:08:26.456″
      },
        {
          ″id″: 5,
          ″speakerType″: ″Agent″,
          ″speakerId″: ″Bob″,
          ″utterenceText″: ″I'm sorry to hear that. You can reset it at our website
        https://nice.com″,
          ″timestamp″: ″2022-09-17 19:08:29.967″
          }
    ]
  }
6. Sampled Interaction
  {
          ″interaction_id″:″78346387-9838-k3kj-98jj-3489757889″,
          ″tenant_id″:″iuj238h2-kj29-kj23-j23k-iou203iu3222″,
          ″start_time″:″2020-11-10 12:34:55.668 Z″,
          ″end_time″:″2020-11-10 12:38:12.345 Z″,
          ″sampling_time″:″2020-11-10 12:38:12.345 Z″,
          ″channel″:″PHONE″,//other possible value - EMAIL/CHAT/SMS
          ″direction″:″INCOMING″,//other possible values - outgoing
          ″customer_id″:″12787248974017124″,
          ″ani″:″334 445 9893″,
          ″dnis″:″374 875 9832″,
          ″agent_users_id”:″98398221-2323-edb0-8732-372372871972″,
          ″skill″:″TERM_INSURANCE″,
        “team_id”: “65267126-0923-kj22-2652-983kjnbv38382”,
  }
7. User Entity
  {
          ″user_id″:″98398221-2323-edb0-8732-372372871972″,
          ″tenant_id″:″iuj238h2-kj29-kj23-j23k-iou203iu3222″,
          ″first_name″ : ″John″,
          ″last_name″ : ″Snow″,
          ″middle_name″:″Dominik″,
          ″role″:″AGENT
  }
8. Team
  {
          “team_id”:”09d58205-9333-4f76-ad8f-2628a6707c0b”
          “team_name”:”Falcons”,
          “team_department”:”RnD”
  }
9. Group
  {
          “group_id”:”84267921-8745-344f-13af-2628a6707c0b”
          “group_name”:”Falcons Evaluators”,
  }
10. Skill
  {
          “skill_id”:”3983242-jk33-iu33-65ee-8237782937423”
          “skill_name”:”Billing”
    }
11. Tenant
  {
          “tenant_id”:”90384jj4239-kj23-vcv4-adwe-nb324mn3b4mb4”
          “tenant_name”:”ABC Corportation”
  }
```

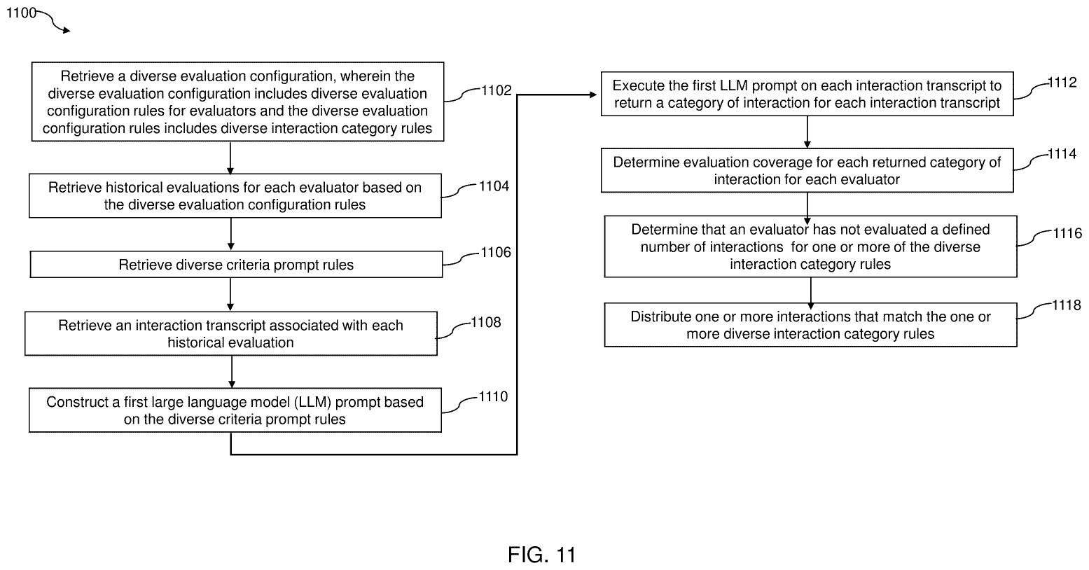

FIG. 11 shows an exemplary method 1100 for distributing diverse interactions for evaluation according to the present disclosure. In step 1102, evaluated interaction categorizer service 130 retrieves a diverse evaluation configuration. The diverse evaluation configuration includes diverse evaluation configuration rules for a plurality of evaluators. The diverse evaluation configuration rules include diverse interaction category rules.

In step 1104, evaluated interaction categorizer service 130 retrieves historical evaluations for each evaluator from the plurality of evaluators based on the diverse evaluation configuration rules.

In step 1106, evaluated interaction categorizer service 130 retrieves diverse criteria prompt rules.

In step 1108, evaluated interaction categorizer service 130 retrieves an interaction transcript associated with each historical evaluation.

In step 1110, evaluated interaction categorizer service 130 constructs a LLM prompt based on the diverse criteria prompt rules.

In step 1112, LLM prompt executor service 145 executes the first LLM prompt on each interaction transcript to return a category of interaction for each interaction transcript.

In step 1114, evaluation coverage service 135 determines evaluation coverage for each returned category of interaction for each evaluator. In various embodiments, determining evaluation coverage for each returned category of interaction for each evaluator includes calculating a DAE score for returned category of interaction for each evaluator. In some embodiments, the method 1100 also includes generating a coverage report that includes the calculated DAE score and displaying the coverage report to a manager of the evaluator.

In step 1116, evaluation coverage service 135 determines that an evaluator has not evaluated a defined number of interactions for one or more of the diverse interaction category rules. In various embodiments, determining that an evaluator has not evaluated a defined number of interactions for one or more of the diverse interaction category rules includes reviewing the coverage report.

In step 1118, evaluation assignor service 165 distributes one or more interactions that match the one or more diverse interaction category rules to the evaluator for evaluation. In one or more embodiments, distributing one or more interactions that match the one or more diverse interaction category rules to the evaluator for evaluation includes retrieving a plurality of interactions for the evaluator, analyzing the retrieved plurality of interactions to ensure the retrieved plurality of interactions match the one or more diverse interaction category rules, and assigning the analyzed, retrieved plurality of interactions to the evaluator. In several embodiments, retrieving a plurality of interactions for the evaluator includes determining a defined number of unique interactions from the diverse evaluation configuration rules, applying a sampling factor to the defined number of unique interactions, and sampling interactions from an interaction database based on the diverse evaluation configuration rules. In some embodiments, analyzing the retrieved plurality of interactions to ensure the retrieved interactions match the one or more diverse interaction category rules includes constructing a second LLM prompt based on the diverse criteria prompt rules, executing the second LLM prompt on each sampled interaction to return a category of interaction for each sampled interaction, and filtering out the sampled interactions that match the one or more diverse interaction category rules. In various embodiments, assigning the analyzed, retrieved plurality of interactions to the evaluator for evaluation includes mapping the filtered, sampled interactions to the evaluator based on the coverage report, and creating evaluation tasks for the evaluator.

Simulations were performed to test the accuracy of the LLM prompt and the LLM prompt executor service 145.

### Simulation 1

Call scenario:
The customer is from North Britain.
Customer called for reporting issue with internet connection.
Agent suggested multiple work around but couldn't fix the issue.
Customer got dissatisfied.
Agent schedules a technical person visit for customer.

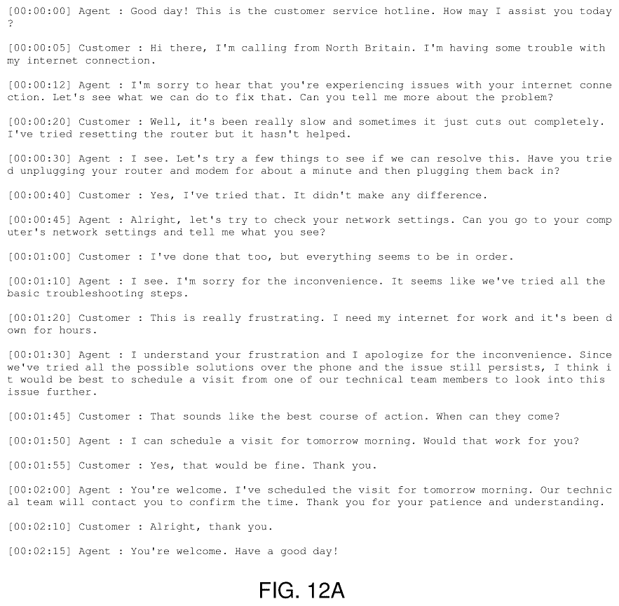

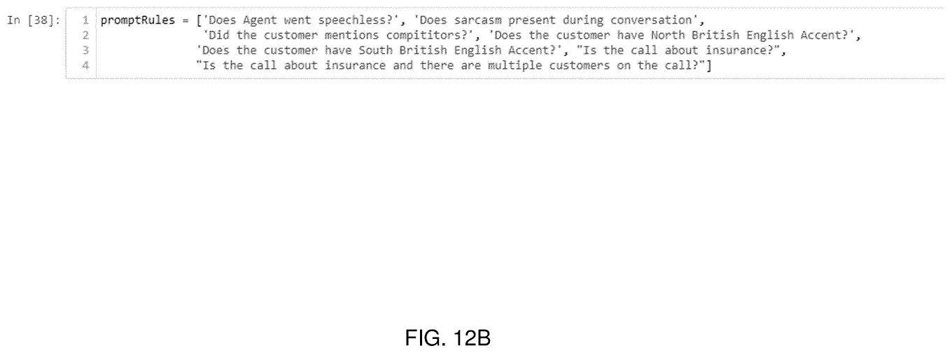

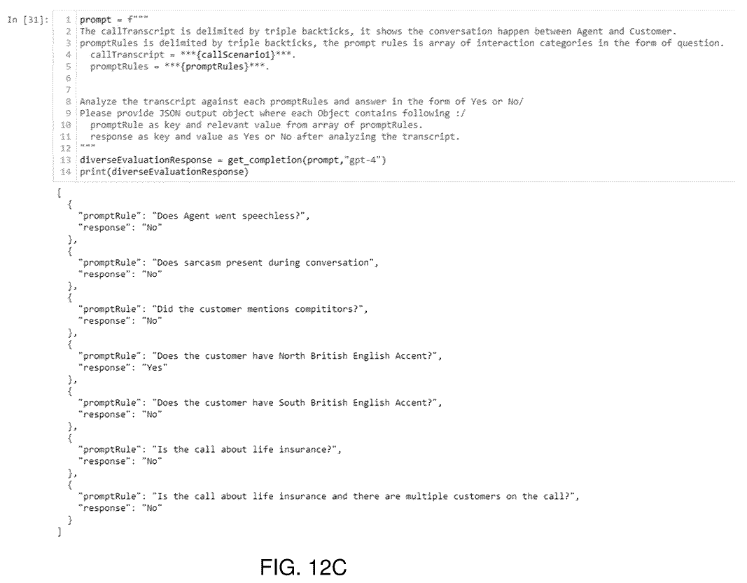

The call transcript is provided in FIG. 12A, the prompt rules are set up in FIG. 12B, and execution of the prompt rules to analyze the category of the call transcript is provided in FIG. 12C. The test results are shown in Table 2.

TABLE 2
RESULTS FOR SIMULATION 1

| Prompt Rules | Expected Result | Actual Result |
|---|---|---|
| Agent went speechless? | No | No |
| Sarcasm | No | No |
| Competitor Mentions | No | No |
| Regional Accent NBE | Yes | Yes |
| Regional Accent SBE | No | No |
| Compliance - Insurance - Basic | No | No |
| Compliance - Insurance - | No | No |
| Multiple Customer | | |

### Simulation 2

Call scenario:
The customer is from South Britain.
Customer called for reporting issue with internet connection.
Agent suggested multiple work around but couldn't fix the issue.
Customer starts talking in sarcasm.
Agent schedules a technical person visit for customer.

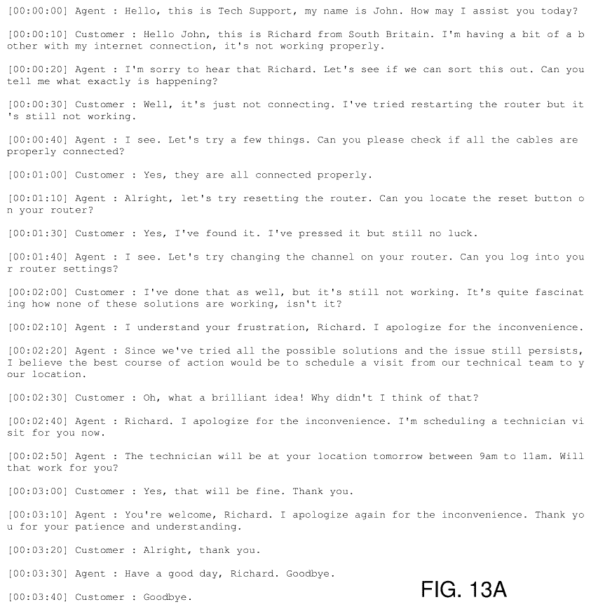

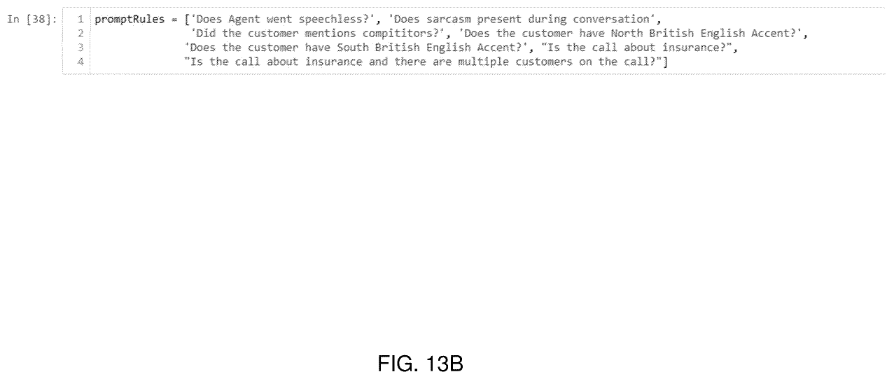

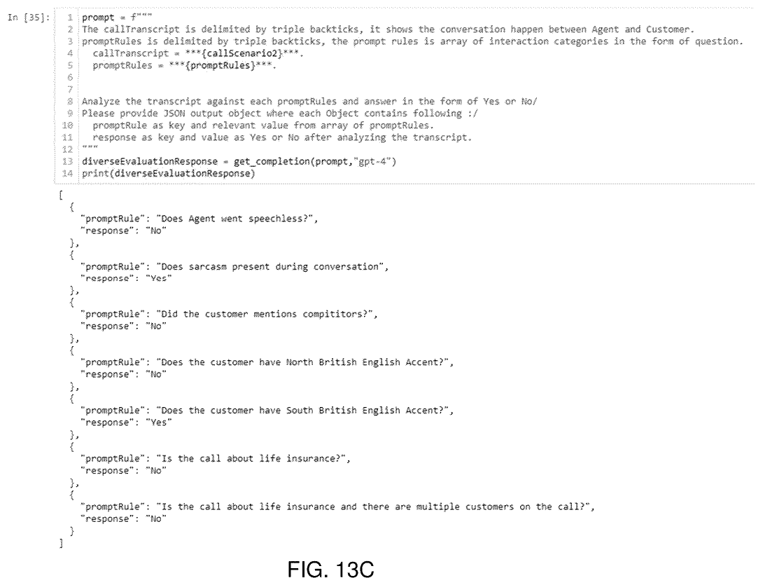

The call transcript is provided in FIG. 13A, the prompt rules are set up in FIG. 13B, and execution of the prompt rules to analyze the category of the call transcript is provided in FIG. 13C. The test results are shown in Table 3.

TABLE 3
RESULTS FOR SIMULATION 2

| Prompt Rules | Expected Result | Actual Result |
|---|---|---|
| Agent went speechless? | No | No |
| Sarcasm | Yes | Yes |
| Competitor Mentions | No | No |
| Regional Accent NBE | No | No |
| Regional Accent SBE | Yes | Yes |
| Compliance - Insurance - Basic | No | No |
| Compliance - Insurance - | No | No |
| Multiple Customer | | |

### Simulation 3

Call scenario:
Agent called the customer to sell medical insurance plan.
The customer is from India.
Agent explained all the available plans.
The customer bargains by mentioning other companies plans.
Agent explains the benefits of his plan and customer agrees to purchase.

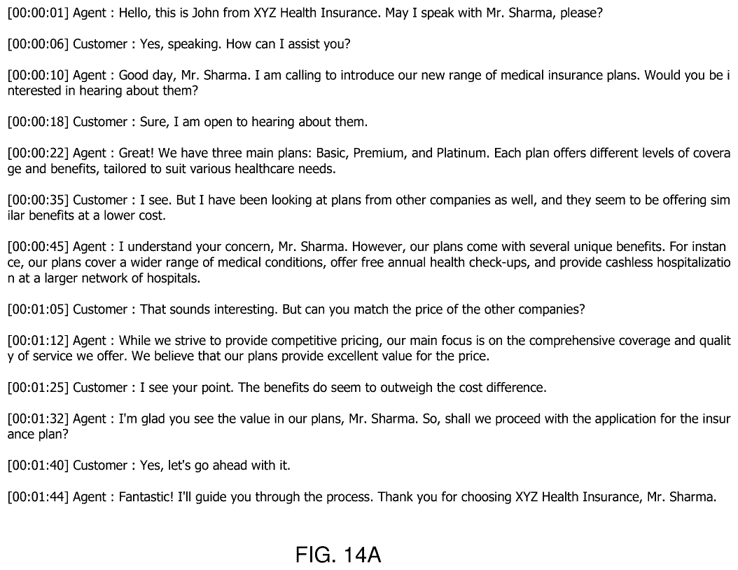

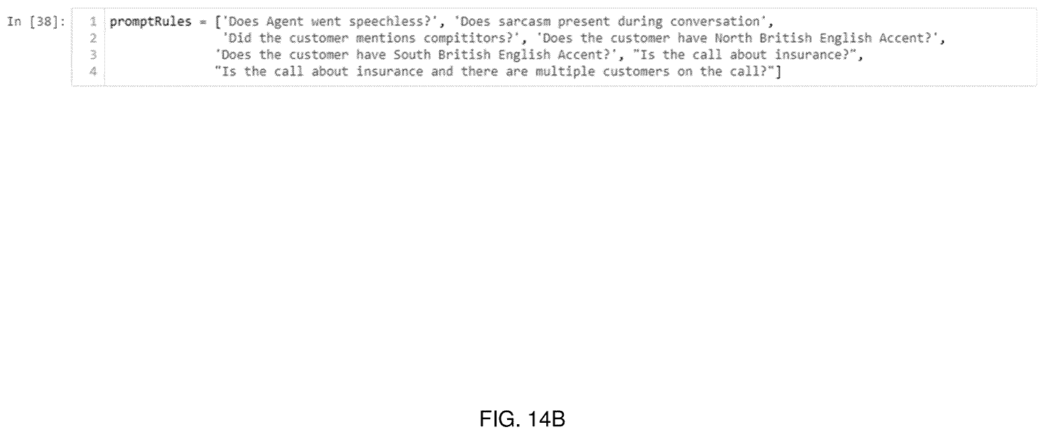

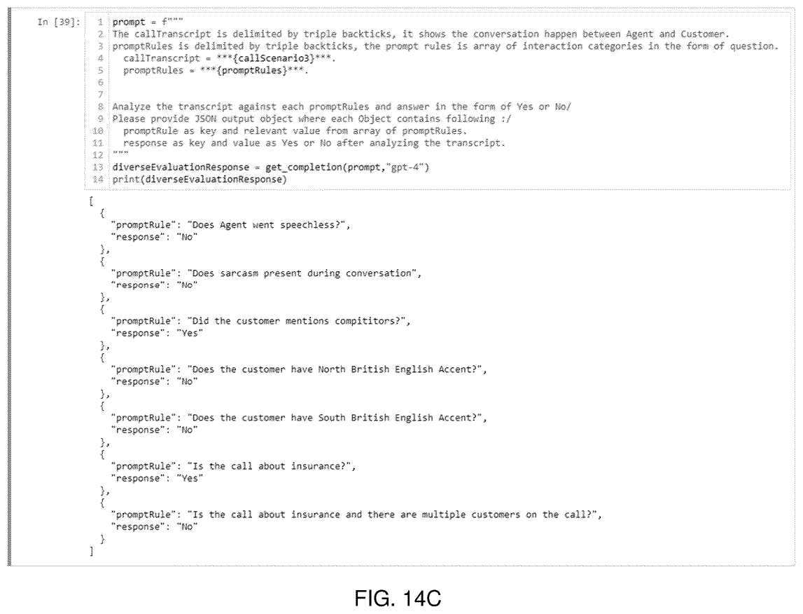

The call transcript is provided in FIG. 14A, the prompt rules are set up in FIG. 14B, and execution of the prompt rules to analyze the category of the call transcript is provided in FIG. 14C. The test results are shown in Table 4.

TABLE 4
RESULTS FOR SIMULATION 3

| Prompt Rules | Expected Result | Actual Result |
|---|---|---|
| Agent went speechless? | No | No |
| Sarcasm | No | No |
| Competitor Mentions | Yes | Yes |
| Regional Accent NBE | No | No |
| Regional Accent SBE | No | No |
| Compliance - Insurance - Basic | Yes | Yes |
| Compliance - Insurance - | No | No |
| Multiple Customer | | |

### Simulation 4

Call scenario:
Agent called the customer to verify customer information for the family medical insurance plan.
It is a joint insurance plan of 4 customers. The customer family is from America.
Agent verified all 4 customers one by one.

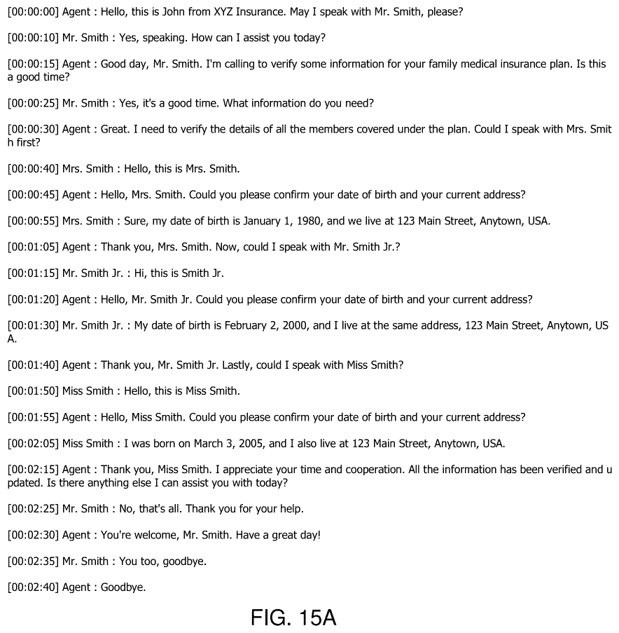

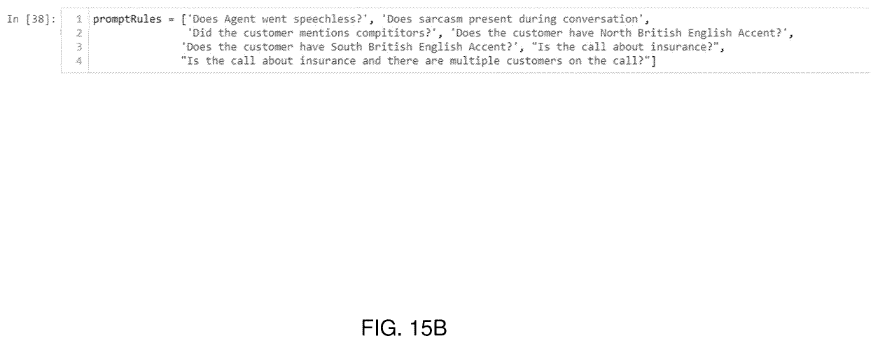

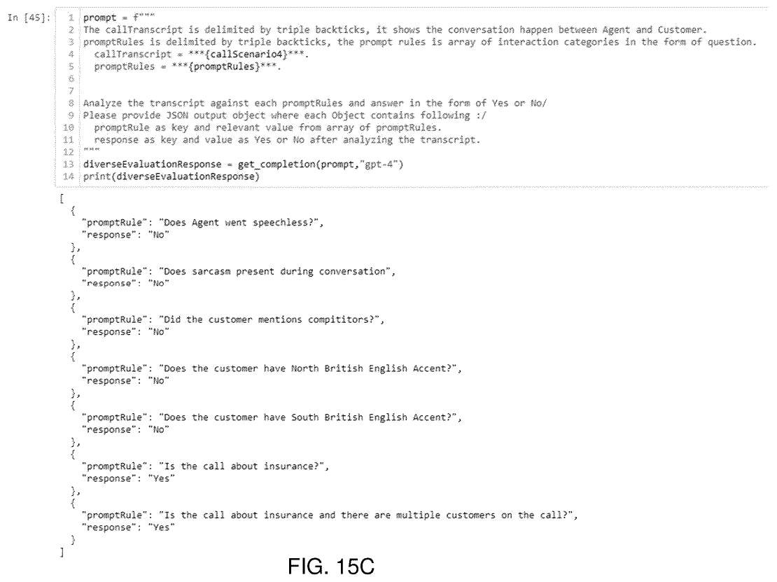

The call transcript is provided in FIG. 15A, the prompt rules are set up in FIG. 15B, and execution of the prompt rules to analyze the category of the call transcript is provided in FIG. 15C. The test results are shown in Table 5.

TABLE 5
RESULTS FOR SIMULATION 4

| Prompt Rules | Expected Result | Actual Result |
|---|---|---|
| Agent went speechless? | No | No |
| Sarcasm | No | No |
| Competitor Mentions | No | No |
| Regional Accent NBE | No | No |
| Regional Accent SBE | No | No |
| Compliance - Insurance - Basic | Yes | Yes |
| Compliance - Insurance - | Yes | Yes |
| Multiple Customer | | |

### Simulation 5

Call scenario:
The customer called to get his Air conditioned replaced.
Agent asks for details.
The moment customer says that all of his 3 AC stopped working and needs replacement, the agent went speech less.
Agent took time to figure out how to reply and finally registers the request.

The call transcript is provided in FIG. 16A, the prompt rules are set up in FIG. 16B, and execution of the prompt rules to analyze the category of the call transcript is provided in FIG. 16C. The test results are shown in Table 6.

TABLE 6
RESULTS FOR SIMULATION 5

| Prompt Rules | Expected Result | Actual Result |
|---|---|---|
| Agent went speechless? | Yes | Yes |
| Sarcasm | No | No |
| Competitor Mentions | No | No |
| Regional Accent NBE | No | No |
| Regional Accent SBE | No | No |
| Compliance - Insurance - Basic | No | No |
| Compliance - Insurance - | No | No |
| Multiple Customer | | |

As shown in all five simulations, the LLM prompt was able to accurately identify the categories of all five scenarios. The test was run against 300 various interactions from five different domains (insurance, credit card, telemarketing, internet, and services), and there were ten different categories of interaction. The LLM prompt was able to accurately identify the interaction categories.

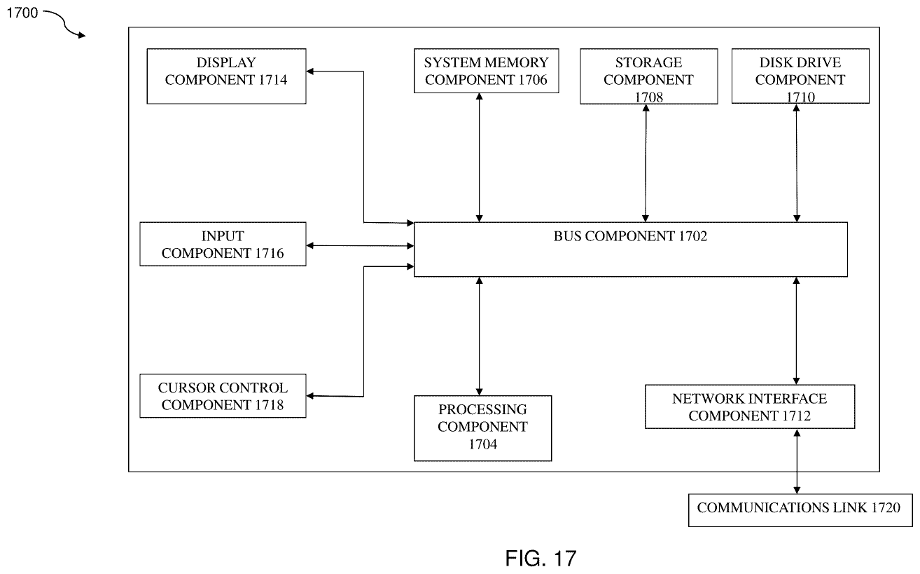

Referring now to FIG. 17, illustrated is a block diagram of a system 1700 suitable for implementing embodiments of the present disclosure. System 1700, such as part of a computer and/or a network server, includes a bus 1702 or other communication mechanism for communicating information, which interconnects subsystems and components, including one or more of a processing component 1704 (e.g., processor, micro-controller, digital signal processor (DSP), etc.), a system memory component 1706 (e.g., RAM), a static storage component 1708 (e.g., ROM), a network interface component 1712, a display component 1714 (or alternatively, an interface to an external display), an input component 1716 (e.g., keypad or keyboard), and a cursor control component 1718 (e.g., a mouse pad).

In accordance with embodiments of the present disclosure, system 1700 performs specific operations by processor 1704 executing one or more sequences of one or more instructions contained in system memory component 1706. Such instructions may be read into system memory component 1706 from another computer readable medium, such as static storage component 1708. These may include instructions to retrieve a diverse evaluation configuration, wherein the diverse evaluation configuration comprises diverse evaluation configuration rules for a plurality of evaluators and the diverse evaluation configuration rules comprise diverse interaction category rules; retrieve historical evaluations for each evaluator from the plurality of evaluators based on the diverse evaluation configuration rules; retrieve diverse criteria prompt rules; retrieve an interaction transcript associated with each historical evaluation; construct a first large language model (LLM) prompt based on the diverse criteria prompt rules; execute the first LLM prompt on each interaction transcript to return a category of interaction for each interaction transcript; determine evaluation coverage for each returned category of interaction for each evaluator; determine that an evaluator has not evaluated a defined number of interactions for one or more of the diverse interaction category rules; and distribute one or more interactions that match the one or more diverse interaction category rules to the evaluator for evaluation. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1704 for execution. Such a medium may take many forms, including but not limited to, non-volatile media, volatile media, and transmission media. In various implementations, volatile media includes dynamic memory, such as system memory component 1706, and transmission media includes coaxial cables, copper wire, and fiber optics, including wires that comprise bus 1702. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1700. In various other embodiments, a plurality of systems 1700 coupled by communication link 1720 (e.g., LAN, WLAN, PTSN, or various other wired or wireless networks) may perform instruction sequences to practice the disclosure in coordination with one another. Computer system 1700 may transmit and receive messages, data, information and instructions, including one or more programs (i.e., application code) through communication link 1720 and communication interface 1712. Received program code may be executed by processor 1704 as received and/or stored in disk drive component 1710 or some other non-volatile storage component for execution.

The Abstract at the end of this disclosure is provided to comply with 37 C.F.R. § 1.72 (b) to allow a quick determination of the nature of the technical disclosure. It is submitted with the understanding that it will not be used to interpret or limit the scope or meaning of the claims.

What is claimed is:

1. An interaction distribution system comprising:
a processor and a non-transitory computer readable medium operably coupled thereto, the non-transitory computer readable medium comprising a plurality of instructions stored in association therewith that are accessible to, and executable by, the processor, to perform operations which comprise:
retrieving a diverse evaluation configuration, wherein the diverse evaluation configuration comprises diverse evaluation configuration rules for a plurality of evaluators and the diverse evaluation configuration rules comprise diverse interaction category rules;
retrieving historical evaluations for each evaluator from the plurality of evaluators based on the diverse evaluation configuration rules;
retrieving diverse criteria prompt rules;
retrieving an interaction transcript associated with each historical evaluation;
constructing a first large language model (LLM) prompt based on the diverse criteria prompt rules;
executing the first LLM prompt on each interaction transcript to return a category of interaction for each interaction transcript;
determining evaluation coverage for each returned category of interaction for each evaluator;
determining that an evaluator has not evaluated a defined number of interactions for one or more of the diverse interaction category rules; and
distributing one or more interactions that match the one or more diverse interaction category rules to the evaluator for evaluation.

2. The interaction distribution system of claim 1, wherein the diverse evaluation configuration rules further comprise one or more interaction selection rules, names of evaluators, and an evaluation assignment schedule.

3. The interaction distribution system of claim 1, wherein determining evaluation coverage for each returned category of interaction for each evaluator comprises calculating a diverse assignment of evaluation (DAE) score for each returned category of interaction for each evaluator.

4. The interaction distribution system of claim 3, wherein the operations further comprise:
generating a coverage report that includes the calculated DAE score; and
displaying the coverage report to a manager of the evaluator.

5. The interaction distribution system of claim 4, wherein determining that an evaluator has not evaluated a defined number of interactions for one or more of the diverse interaction category rules comprises reviewing the coverage report.

6. The interaction distribution system of claim 1, wherein distributing one or more interactions that match the one or more diverse interaction category rules to the evaluator for evaluation comprises:
retrieving a plurality of interactions for the evaluator;
analyzing the retrieved plurality of interactions to ensure the retrieved plurality of interactions match the one or more diverse interaction category rules; and
assigning the analyzed, retrieved plurality of interactions to the evaluator.

7. The interaction distribution system of claim 6, wherein retrieving a plurality of interactions for the evaluator comprises:
determining a defined number of unique interactions from the diverse evaluation configuration rules;
applying a sampling factor to the defined number of unique interactions; and
sampling interactions from an interaction database based on the diverse evaluation configuration rules.

8. The interaction distribution system of claim 7, wherein analyzing the retrieved plurality of interactions to ensure the retrieved interactions match the one or more diverse interaction category rules comprises:
constructing a second LLM prompt based on the diverse criteria prompt rules;
executing the second LLM prompt on each sampled interaction to return a category of interaction for each sampled interaction; and
filtering out the sampled interactions that match the one or more diverse interaction category rules.

9. The interaction distribution system of claim 8, wherein assigning the analyzed, retrieved plurality of interactions to the evaluator for evaluation comprises
mapping the filtered, sampled interactions to the evaluator based on the coverage report; and
creating evaluation tasks for the evaluator.

10. A method for distributing interactions for evaluation, which comprises:
retrieving a diverse evaluation configuration, wherein the diverse evaluation configuration comprises diverse evaluation configuration rules for a plurality of evaluators and the diverse evaluation configuration rules comprise diverse interaction category rules;
retrieving historical evaluations for each evaluator from the plurality of evaluators based on the diverse evaluation configuration rules;
retrieving diverse criteria prompt rules;
retrieving an interaction transcript associated with each historical evaluation;
constructing a first large language model (LLM) prompt based on the diverse criteria prompt rules;
executing the first LLM prompt on each interaction transcript to return a category of interaction for each interaction transcript;
determining evaluation coverage for each returned category of interaction for each evaluator;
determining that an evaluator has not evaluated a defined number of interactions for one or more of the diverse interaction category rules; and
distributing one or more interactions that match the one or more diverse interaction category rules to the evaluator for evaluation.

11. The method of claim 10, wherein determining evaluation coverage for each returned category of interaction for each evaluator comprises calculating a diverse assignment of evaluation (DAE) score for each returned category of interaction for each evaluator.

12. The method of claim 11, which further comprises:
generating a coverage report that includes the calculated DAE score; and
displaying the coverage report to a manager of the evaluator.

13. The method of claim 10, wherein distributing one or more interactions that match the one or more diverse interaction category rules to the evaluator for evaluation comprises:
retrieving a plurality of interactions for the evaluator;
analyzing the retrieved plurality of interactions to ensure the retrieved plurality of interactions match the one or more diverse interaction category rules; and
assigning the analyzed, retrieved plurality of interactions to the evaluator.

14. The method of claim 13, wherein retrieving a plurality of interactions for the evaluator comprises:
determining a defined number of unique interactions from the diverse evaluation configuration rules;
applying a sampling factor to the defined number of unique interactions; and
sampling interactions from an interaction database based on the diverse evaluation configuration rules.

15. The method of claim 14, wherein analyzing the retrieved plurality of interactions to ensure the retrieved interactions match the one or more diverse interaction category rules comprises:
constructing a second LLM prompt based on the diverse criteria prompt rules;
executing the second LLM prompt on each sampled interaction to return a category of interaction for each sampled interaction; and
filtering out the sampled interactions that match the one or more diverse interaction category rules.

16. A non-transitory computer-readable medium having stored thereon computer-readable instructions executable by a processor to perform operations which comprise:
building a library comprising previously identified stressful sentences and stressful phrases;
retrieving a diverse evaluation configuration, wherein the diverse evaluation configuration comprises diverse evaluation configuration rules for a plurality of evaluators and the diverse evaluation configuration rules comprise diverse interaction category rules;
retrieving historical evaluations for each evaluator from the plurality of evaluators based on the diverse evaluation configuration rules;
retrieving diverse criteria prompt rules;
retrieving an interaction transcript associated with each historical evaluation;
constructing a first large language model (LLM) prompt based on the diverse criteria prompt rules;
executing the first LLM prompt on each interaction transcript to return a category of interaction for each interaction transcript;
determining evaluation coverage for each returned category of interaction for each evaluator;
determining that an evaluator has not evaluated a defined number of interactions for one or more of the diverse interaction category rules; and
distributing one or more interactions that match the one or more diverse interaction category rules to the evaluator for evaluation.

17. The non-transitory computer-readable medium of claim 16, wherein determining evaluation coverage for each returned category of interaction for each evaluator comprises calculating a diverse assignment of evaluation (DAE) score for each returned category of interaction for each evaluator.

18. The non-transitory computer-readable medium of claim 17, wherein the operations further comprise:
generating a coverage report that includes the calculated DAE score; and
displaying the coverage report to a manager of the evaluator.

19. The non-transitory computer-readable medium of claim 16, wherein distributing one or more interactions that match the one or more diverse interaction category rules to the evaluator for evaluation comprises:
retrieving a plurality of interactions for the evaluator;
analyzing the retrieved plurality of interactions to ensure the retrieved plurality of interactions match the one or more diverse interaction category rules; and
assigning the analyzed, retrieved plurality of interactions to the evaluator.

20. The non-transitory computer-readable medium of claim 19, wherein retrieving a plurality of interactions for the evaluator comprises:
determining a defined number of unique interactions from the diverse evaluation configuration rules;
applying a sampling factor to the defined number of unique interactions; and
sampling interactions from an interaction database based on the diverse evaluation configuration rules, and
wherein analyzing the retrieved plurality of interactions to ensure the retrieved interactions match the one or more diverse interaction category rules comprises:
constructing a second LLM prompt based on the diverse criteria prompt rules;
executing the second LLM prompt on each sampled interaction to return a category of interaction for each sampled interaction; and
filtering out the sampled interactions that match the one or more diverse interaction category rules.
